(19) United States
(12) Patent Application Publication
(10) Pub. No.: US 2008/0065695 A1
(43) Pub. Date: Mar. 13, 2008

(54) SYSTEM AND METHOD FOR NONDETERMINISTIC MEDIA PLAYBACK SELECTED FROM A PLURALITY OF DISTRIBUTED MEDIA LIBRARIES

(75) Inventors: Kjell Roland Adstedt, Scottsdale, AZ (US); Joakim Alexander Sternberg, Edina, MN (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: PIVI UNLIMITED LLC

(21) Appl. No.: 11/852,988

(22) Filed: Sep. 10, 2007

Related U.S. Application Data
(60) Provisional application No. 60/843,618, filed on Sep. 11, 2006.

(51) Int. Cl. G06F 17/00

(52) U.S. Cl. 707/104.1; 707/E17.102

(57) ABSTRACT

A system for the capture, classification, and playback of media content provides users with a turn-key solution for uploading captured media content and classifying it. The playback of media content is based on user selected classification preferences, whereby the system automatically generates media content sequences and music tracks based on the classifications.

### RELATED APPLICATION

This application claims the benefit of and priority to U.S. Provisional Application Ser. No. 60/843,618, filed Sep. 11, 2006, entitled “System and methods for nondeterministic media play back selected from a plurality of distributed media libraries,” the contents of which are incorporated by reference herein in its entirety.

### BACKGROUND

This disclosure relates to a novel systems and methods for the organization and editing of audiovisual materials, such as video footage and sound recordings.

### SUMMARY

A system for the capture, classification, and playback of media content provides users with an turn-key solution for uploading captured media content and classifying it. The playback of media content is based on user selected classification preferences, whereby the system automatically generates media content sequences and music tracks based on the classifications.

According to a feature of the present disclosure, a system is disclosed comprising at least one computer connected to a media content source and having a media content source storage device, wherein the at least one computer receives and classifies media content; at least one of a visual output device and an audio output device; a network connection; and a global service directory maintained by a third party. The media content is classified into at least one preselected classification and playback of the media content is automatically determined based on selection of at least one classification preference.

According to a feature of the present disclosure, a method is disclosed comprising providing a tool for capturing media content, wherein the media content is stored in a media content storage, providing a classifier to classify the captured media content, wherein a user is allowed to predefined classification categories, allowing a user to classify media content with the classifier to form classified media content stored in a classification database, and providing a player for playing the media content. The player automatically selects media content after allowing a user to select preferences of classification categories.

According to a feature of the present disclosure, a machine readable medium is disclosed having instructions stored thereon for performing a process comprising providing a tool for capturing media content, wherein the media content is stored in a media content storage; providing a classifier to classify the captured media content, wherein a user is allowed to predefined classification categories; allowing a user to classify media content with the classifier to form classified media content stored in a classification database; and providing a player for playing the media content. The player automatically selects media content after allowing a user to select preferences of classification categories.

According to features of the present disclosure, products by the processes disclosed herein are expressly contemplated.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram of an embodiment of a media classification and playback system distributed over a wide area network;

FIG. 2 is a flow diagram of an embodiment of a media content classification system;

FIG. 3 is a flow diagram of an embodiment of a playback system; and

FIG. 4 is a flow diagram of an embodiment of a global directory service module.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, biological, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

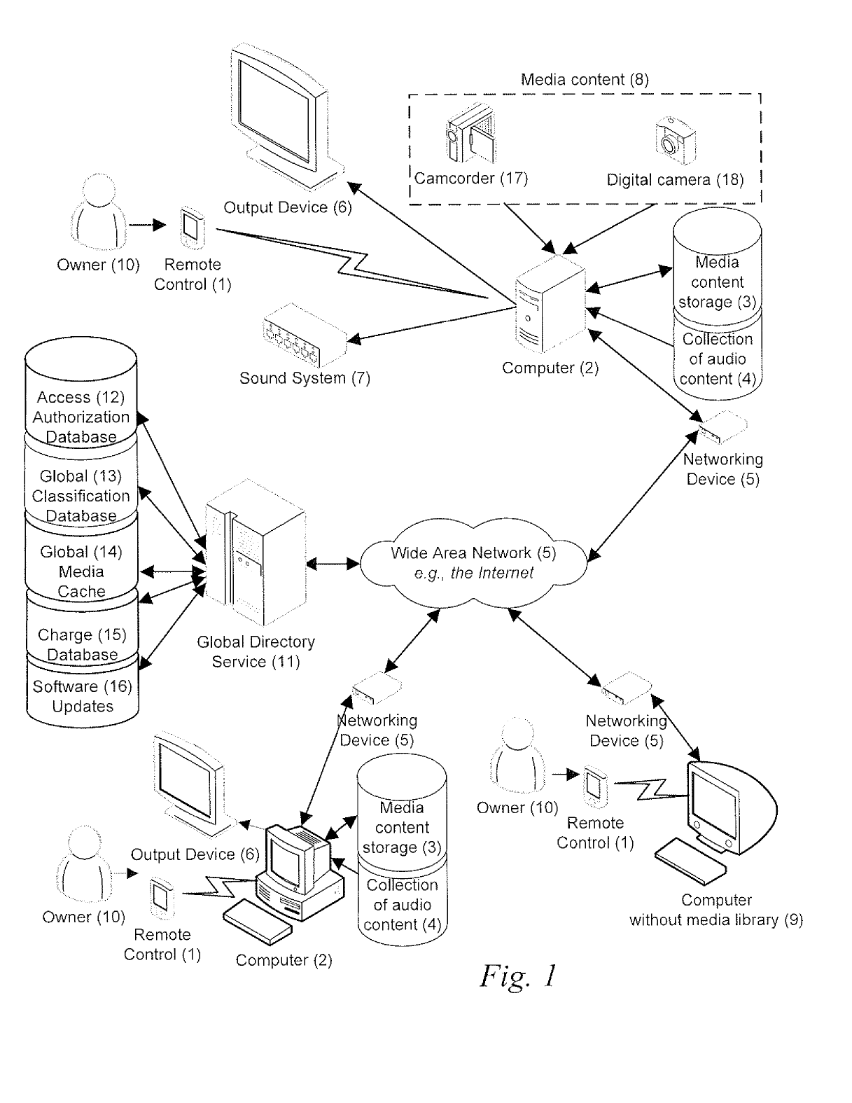

According to embodiments, FIG. 1 illustrates the components of a media content classification and playback system. The media classification and playback system provides a platform for improved editing and playback of audiovisual content.

According to embodiments, remote control device 1 and general purpose or proprietary computer 2 having sufficient media content storage 3 are used by owner 10 in conjunction with the present system. Computer 2 is optionally connected to a local collection of music files 4, wide area network 5, video output device 6, or audio output device 7. Remote control device 1 allows for fast and convenient input when classifying original media content 8, which is obtained from camcorder 17, digital camera 18, or functionally equivalent devices used to capture video or audio content. Remote control 1, according to embodiment, facilitates full interaction with the media classification and playback system. Artisans will appreciate that the functions and features of the media classification and playback system are available via alternative input devices such as keyboards, mouses, touch screens, and other input devices that may be connected to a computer and used for purposes of input.

The media classification and playback system is designed for either individual use or as a distributed system. When used as a distributed system and according to embodiments, the individual configuration of each distributed system is independent of the configuration of the other systems. Each individual computer 2 is a computer running any major operating system or configured as a proprietary computer and optimized for this process. To enhance the experience, the computer my be part of a home theater PC (HTPC) or connected to a home theater system.

To be used as a distributed system, each computer 2 must be connected to a network via a network device 5. Networked computers may be connected via the internet or local area networks, according to embodiments. According to embodiments, computer 9, which does not provide media storage, may connect to the media classification and playback system whereby it is configured for media contents playback of media content 8 stored remotely. According to embodiments, remote computer 9 may also have editing and classification functionality enabled.

Prior to classification and editing of media content 8, the owner of the media classification and playback system must complete a setup process, which includes at least calibration of a classification structure. According to embodiments, a classification hierarchy is designed to reflect typical scenarios captured in the media content. For example, a classification hierarchy may comprise: names of family members and pets, locations visited, common events or situations, and the type of shot (e.g., establishing, cutaway, cut-in, reaction, etc.). Calibration of the classification system is accomplished, according to embodiments, using an input mechanism, such as remote control 1. Calibration increases the speed by which classification of media contents is accomplished by allowing the user of the system to select predefined values instead of having to enter classification information in real time during the capture or editing process. After calibration, the media classification and playback system is ready for use. The calibration process may be repeated or adjusted at a later point in time, according to embodiments.

According to embodiments, during the setup process owner 10 preauthorizes media access to owners 10 of distributed systems for viewing or editing of media content 8. Preauthorization may also be performed at a later time. According to embodiments, preauthorization may be performed for specific owners 10, such as friends and family, or preauthorization is granted for all users. Each owner 10 registers with a unique identity in combination with a password. Identification of owners during the preauthorization process is accomplished by entering the unique identity or email address, according to embodiments.

According to embodiments, remote owners 10 are authorized for access to media content 8 on another distributed system by entering their unique identity and password. If the unique identity of the requester was preauthorized then a connection to media content 8 is established immediately. Otherwise, connection to media content 8 of the remote system is permitted as soon as owner 10 of media content 8 approves the request for authorization, which is automatically prompted on owner's 10 next access to the media classification and playback system.

According to embodiments, discovery and authorization of accessible distributed systems is coordinated by global directory service 11, which comprises a set of dedicated network servers for all computers 2 participating in the distribution of media content 8. The network servers do not transfer media contents 8 to remote computers 2, 9 for private media content, according to embodiments. However, in cases where the preauthorization is for all users, global directory service 11 servers may directly facilitate transfer of media content 8 to users. Global directory service 11 facilitates interconnection of computer 2, 9 with media content 8. Once computer 2, 9 acquire the necessary connection information, global directory service 11 is not used further. If computer 2, 9 is disconnected from media content, global directory service 11 is again used to reconnect computer 2,9 with media content 8.

Global directory service 11 comprises, according to embodiments, access authorization database 12, global classification database 13, global media cache 14, charge database 15, and software update module 16. Access authorization database handles the authorization and preauthorization processes described above. Global classification database 13 contains classification information for shared media content 8. Use of a classification database improves performance by aggregating media content 8 available to all users in a central, searchable database, which then facilitates connection of anonymous users with media content 8.

Global media cache 14 stores frequently accessed media contents, i.e., the most popular media content 8, thereby preventing networking bottlenecks and speeding up network transfer of media content 8. According to embodiments, global media cache 14 stores and either uploads or streams media content 8 to remote computers 2, 9 directly.

Charge database 15 is a service used to charge viewers for accessing anonymously shared media content, if so dictated by the owner of media content 8. Finally, global directory service 11 comprises a software updates module 16 that is a repository for software updates that are automatically propagated to computers 2, 9 when new versions of the software are available or make the software updates available for download, according to embodiments.

The computer running the media classification and playback system will typically comprise a plurality of interfaces to connect devices used to produce media contents. Typical connection interfaces includes but is not limited to: USB, FireWire (i.e., IEEE-1394, i.Link, DV), analog video (S-video/RCA) and audio (mini-plug/RCA), or digital video or audio connections (HDMI). Typical media content devices used to capture media content 8 include, according to embodiments, but are not limited to: camcorders 17, digital cameras 18, cell phones, digital scanners, and audio capture devices.

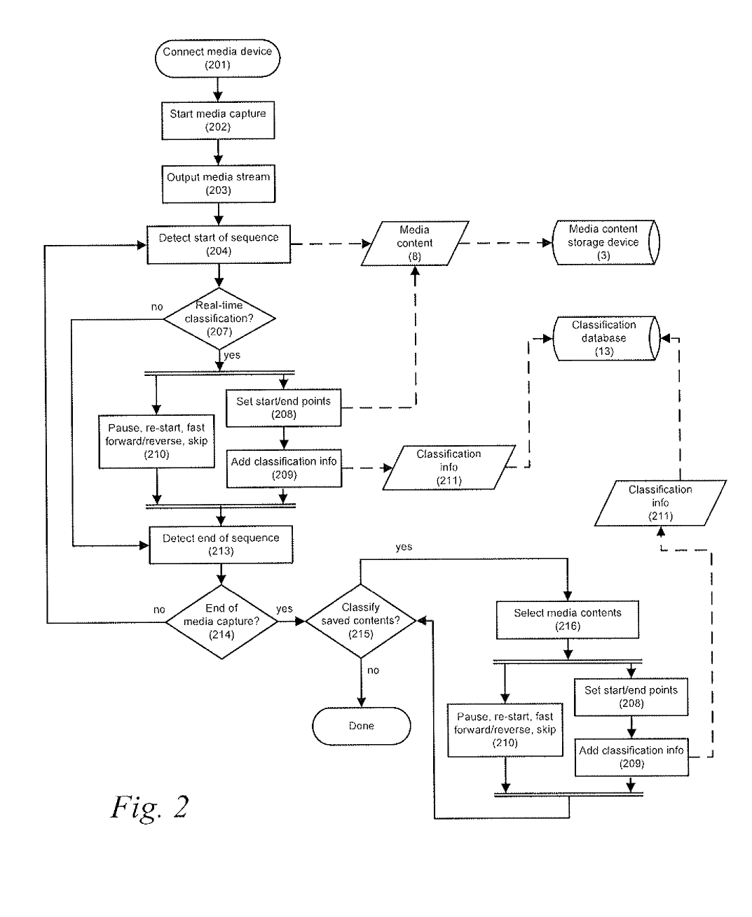

According to embodiments and as illustrated in FIG. 2, a classification process is shown. The user of the media classification and playback system connects a device containing the media to be classified to the appropriate connection in operation 201 and causes the system to start a media capture in operation 202. The media classification and playback system automatically starts playing back the media on an output device, such as a computer screen or connected TV in operation 203.

During the media capture process, the system detects when one discrete piece of media content starts in operation 204 and ends in operation 213. According to embodiments, determination of the starting and ending points in a given piece of media may be determined by processing the time code on the movie track if capturing from a camcorder, for example. According to other embodiments, for when using digital cameras, each picture of video comprises a discrete media content item.

According to embodiments, each captured piece of media content 8 is saved to storage device 3 connected to computer 2 running the media classification and playback system. The user of the system classifies each piece of media content in operation 209 after setting the start and end point for each sequence in operation 208, which allows the users to “cut” portions of the audiovisual material that isn't desired for later viewing without the need to actually cut the audiovisual material. Setting of the start and end points and classification is performed in real time as media content 8 is being captured in operation 207 or performed in operation 215 after capture of media content has ended (operation 214) in either sequential or non-sequential order in operation 216.

According to embodiments, remote control 1 is used to provide input to the classification process of the media classification and playback system. The user interface shows selected classification choices, which are overlaid over the media content shown on output device 6. According to embodiments, the choices do not substantially block the output of the media content. Remote control 1 is also used to pause, re-start, fast forward, reverse, or skip forward/reverse the presentation of media content 8 during the classification process, if desired, in operation 210.

After each piece of media content 8 has been classified, the classification information 211 is stored in classification database 13. Typical classification information includes but is not limited to: date and time, overall rating, location, motif (persons, animals, buildings, vehicles, etc.), events and situation, mood, type of shot (establishing, cutaway, cut-in, reaction, etc.), or the sharing status of the media content with specific users or all users in the distributed system. According to embodiments, classification information comprises a mix of predefined categories or values and the categories or values defined during the calibration process.

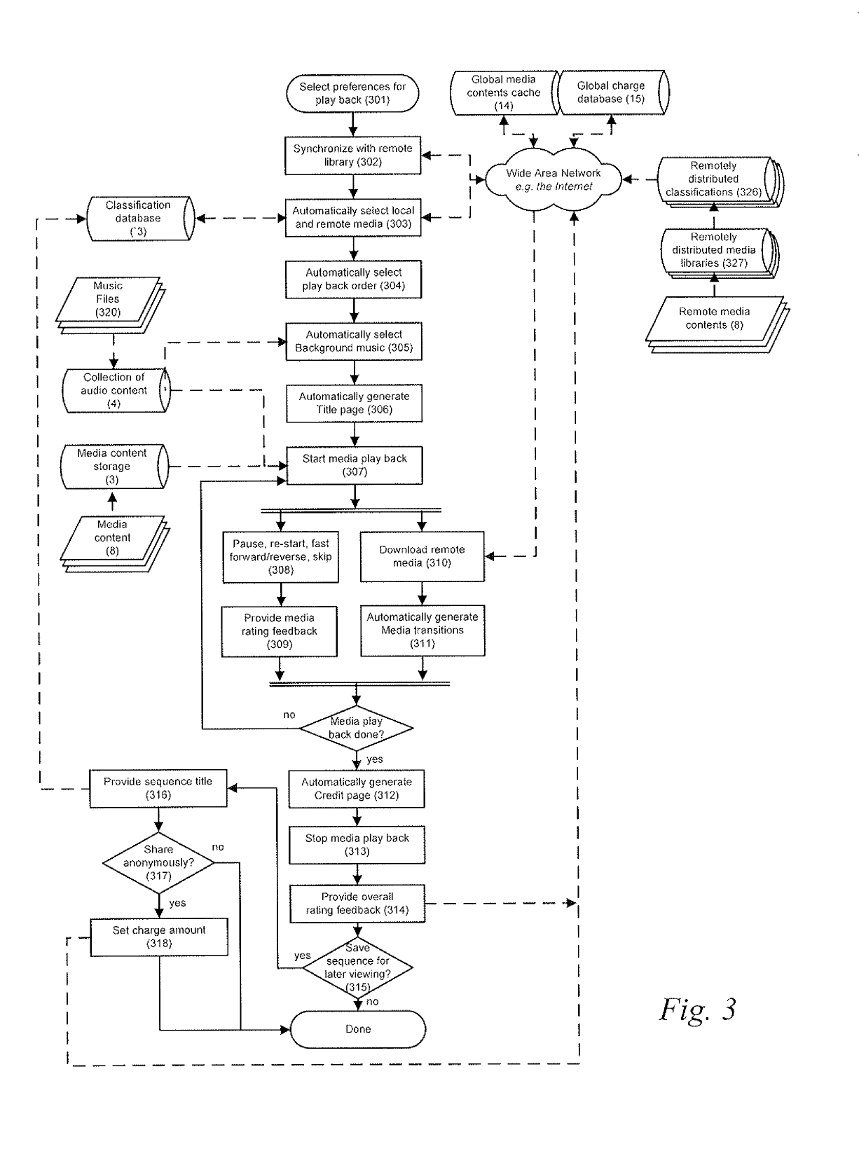

After media content is captured and classified, the system is ready for playback as illustrated in FIG. 3. When a user of the system wishes to watch media content 8 locally from media content storage 3 or remotely from any a distributed systems media content libraries 327 and their accompanying classification 326 that has given authorization, remote control 1 is used to provide input on the preference for the media content that the user wishes to playback in operation 301. These preferences include but are not limited to selection of classification information in operation 303 or connection to a remote library in operation 302. According to embodiments, classification information that may be used to select video includes: date range, total play back time, occasion, motif (persons, animals, buildings, vehicles, etc.), media types to include, and mood, for example. According to embodiments, some classification information is used only to decide in what order to play back media contents in operation 304 and what type of background music to use in operation 305.

To better match the customized classification types used by each individual distributed media library 327, the user may chose to synchronize the classification/preference selection types in operation 302 with one or more distributed classification databases 326. Note that the preferences do not directly identify which pieces of captured media contents to include, whether to use local media content 3 or remote media content 8 (unless so desired), or in what order to play media content 8 back or what background local music 320 to use. Those decisions are made automatically by the playback system in operations 303-305 based on the classification information provided at the time of media capture and user ratings provided after each viewing in operations 309 and 314. Selected preferences only provide general guidance to the media classification and playback system as to the type of classification values the system should search when selecting a sequence of media contents to play back in operation 303.

The actual set of media content to play is derived by first selecting a larger media set based on a search against the local or remotely distributed databases for media content 8 having classification values that match the viewers preferences. This set is then sorted based on earlier provided ratings and finally trimmed down to fit within the requested viewing time. According to embodiments and prior to playback, the media classification and playback system may automatically generate a title page and credit pages in operations 306 and 312.

During playback in operation 307 of the selected sequence 304, the viewer can use remote control 1 to give rating feedback 309 on each segment of media content, and also pause, re-start, fast forward/reverse, or skip forward/reverse the presentation in operation 308. After playback of each sequence is ended or stopped in operation 313, the viewer can use remote control 1 to provide feedback on the quality of the automated selection and editing in operation 314, and save the exact sequence in operation 315 for later playback, recording to external media such as recordable DVDs, or sharing. The selection/editing feedback 314 is used to improve later selections when a similar playback preferences is requested. The viewer provides a sequence title for any saved sequence in operation 316 and if saved for anonymous sharing in operation 317 the viewer decides whether to charge remote viewers for access to the media content in operation 318 as dictated by media content owner. Charge information is recorded in charge database 15 in global directory service 11. When an anonymously shared piece of media content or a whole sequence has been requested with enough frequency, it is saved into global media contents cache 14.

Factors that affects order of playback in operation 304 include time coding and shot type classification, e.g., establishing shots are shown prior to other shots in the same sequence irrespective of the time coding, reaction shots are displayed between a cutaway shot and cut-in shot, etc. Conventional rules of movie editing theory dictate the automatic sequencing, according to embodiments. The media classification and playback system will also automatically create a title page in operation 306 to be shown first and credit page in operation 312, which is shown last. The title page and the credit page will depict the selected play back preferences as well as the original classification information. All media contents in the playback sequence will have automatically generated visual and audio transitions in operation 311 between them to optimize the viewing experience. Additionally, remote media content is automatically downloaded in operation 310 if it is included in the sequence.

According to embodiments, background music is automatically selected from music files 320, which are indexed and classified in collection of ancillary audio content 4. Factors that affect the choice of background music are event type, mood, etc. A preference for Christmas media content will result in Christmas-based music selections being played as the automatic choice of background music. A preference for somber contents all containing the same person to create an in memoriam sequence would result in an equally appropriate choice of background music. The determination of background music is performed on the local computer to preserve network bandwidth, as well as to avoid copyright infringement.

Anonymous access of local media clips is accompanied with background music located on the remote system experiencing the audiovisual media content. According to embodiments, music on the local system is selected from existing collections of music files stored on the local system or connected to the owner's local home network. According to other embodiments, music collections specifically created for the purpose of being used as background music for the system are used in place of or together with ancillary audio content files. Regardless, if the system uses an existing general purpose music collection on the same or locally connected system or a collection specifically created for the use as background music, the music files must be classified, for example by genre, mood, or rating. For example, music may be classified according to an industry standard, for example genres used with CDDB or with arbitrary designations such as children, party, summer, winter, somber, sports, vacation, silly, 4 out of 5 stars, etc. For general purpose collections, classification may be performed using a default application used to create and manage the collection. For collections created specifically for use as background music, the classification features provided by the media classification and playback system are be used instead, according to embodiments. The same classification features may be used to classify the genre of general purpose music collections as well. The media classification and playback system must have music with appropriate classifications to select the appropriate background music for a generated sequence of media content. If the system finds two or more music choices suitable as background music, it will pick the selection with the higher rating, according to embodiments. If the ratings are equal, it plays the music that has been selected the least number of times.

According to embodiments, the media classification and playback system does not use any proprietary file or compression formats to store or transfer media contents. Rather, public domain and commercially licensed standard formats and compression techniques optimized for television playback and wide area network transfer is used, with a focus on compatibility between popular general purpose computer system platforms. Media content stored for local playback is stored in a file and compression format optimized for conservative file size with good viewing quality for playback on a television, according to embodiments. Whenever media content is classified for distributed sharing with other systems, a copy of the media content is created that is optimized for wide area network transfer with acceptable quality for playback on a television. Naturally, this copy will be the same or smaller in size than the file used for local playback. Consequently, the media content storage will fill up faster when sharing content remotely. According to embodiments, the Sorenson Video 3 Pro Codec is used for compression, although nearly any suitable codec may be used as will be well known and understood by artisans.

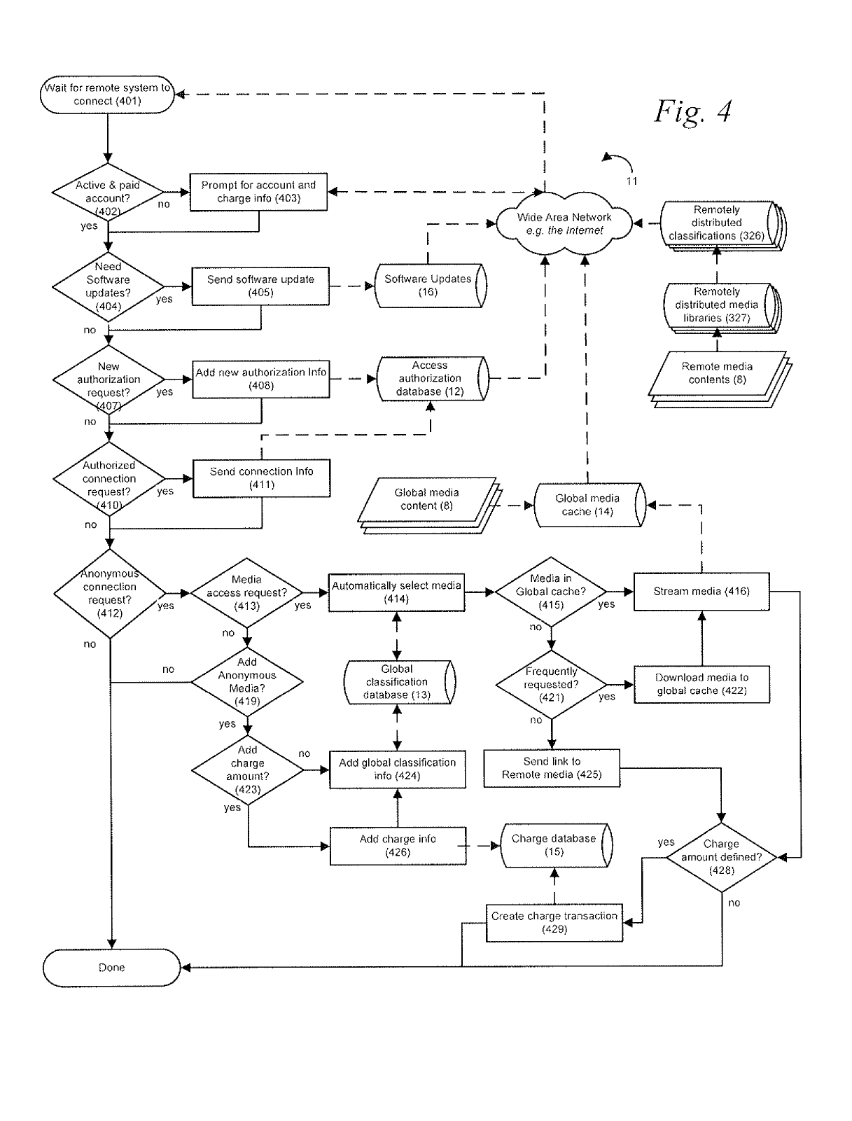

According to embodiments illustrated by FIG. 4, the features of global directory service 11 are diagrammed. Global directory service 11 waits for remote systems to connect in operation 401. After a remote connection is established, a determination that the system connecting is an active and paid account is performed in operation 402. If the account is either not active or not paid, the user of the connecting system is asked to supply necessary information to create a new paid account or update and pay for the account in operation 403.

In operation 404, the media classification and playback system determines if the remote computer needs software updates. If so, the necessary software is uploaded from software updates module 11 to the remote computer for installation in operation 405.

After the initial administrative tasks, global directory service 11 is ready to service the remote media classification and playback system. Global directory service 11 performs at least handling of: requests for authorization in operation 407, requests for connection to other authorized media and classification systems remotely in operation 410 or requests for anonymous services in operation 412.

If a new authorization is required in operation 407, the necessary information is collected and added, in operation 408, to the access authorization database 12. If new authorization is unnecessary, global directory service 11 determines whether authorization is required for connection to the desired media classification and playback system in operation 410. For connection requests, the necessary connection information is retrieved from authorization database 12 and sent to the remote system in operation 411. If authorization is not required, a request for anonymous service of either playback of media in operation 413 or adding media in operation 419 occurs. Media for anonymous playback is selected by matching the remote system's playback preferences 414, as described above, against global classification database 13. Matching media references are checked against global media cache 14 to determine the source of remote media content. If the media content is stored in global media cache 14 as determined in operation 415, the media classification and playback system initiates streaming of media content in operation 416 global media cache 14 to the remote system. If the necessary media content is not in global media cache 14, the global directory service 11 checks if it has been requested frequently enough in operation 421 and if so adds it in operation 422 to global media cache 415. If the media content is not frequently enough requested, the media is streamed directly from the source remote media classification and playback system to the local media classification and playback system in operation 425. Finally, if the owner of anonymously shared media content sets a charge amount for viewing it as determined in operation 428, a charge transaction will be created in operation 429 and added to charge database 15.

If, rather than playback, the remote system wants to add media content for all users as determined in operation 419, global directory service 11 determines whether a charge will apply to the given media content in operation 423. If a charge is desired, the charge information, including at least a price to experience the media content is added to the charge database. The classification information for the media content is also added to global classification database 13, according to embodiments. The actual content media is not be added to global media cache 14 until requested frequently enough.

According to embodiments, the systems and methods of the present disclosure are implemented as a soft appliance (i.e. software implementation that can be executed on a plurality of computer hardware configurations) installed on a general or proprietary computer architecture built from standard components but optimized for running the soft appliance. Specifically the proprietary system has a remote control device for user input. According to embodiments, enough media storage to store a suitable amount audiovisual clips, such as 100 hours, and associated classification info is necessary. A recordable DVD device for recording saved media contents sequences is optional. A graphics processor and CPU combination with enough capacity to decompress and create audio and video transitions between media contents at the time of playback, is also necessary. The following input/output interfaces or functional equivalents are also useful, the application of which will be readily understood by artisans according to embodiments: ethernet for broadband internet, USB for camcorders/digital cameras, IEEE-1394 for camcorders, S-Video and left/right RCA audio input for analog camcorders, or audio output for connection to a home theater system.

According to embodiments, the global directory service process software runs on a plurality of internet connected servers having enough storage for: information about authorization and connectivity between users, automatically installed updates to the soft appliance, a classification information database for anonymously shared media contents, and for storing anonymously shared media that is frequently requested.

According to embodiments, the systems and methods of the present disclosure are executed on a standard computer having a standard Windows-, Mac-, or unix-based operating system with or without connectivity to the Internet, with or without media storage devices, with or without connecting to a home theater system, with or without using a global directory process (either for stand alone use or network sharing without a global directory).

Other variances include using a wide area network other than the internet, e.g. a wide area private network (Intranet) or a local area network (LAN) or support for high definition video, i.e., being able to capture and store media from high definition camcorder devices, being able to play back high definition media on either a computer monitor or a high definition TV connected to the system through a component video, DVI or HDMI interface. Other variances now in existence or developed in the future comprising functional equivalents the components, systems, and methods of the present disclosure that would be readily apparent to artisans are also contemplated.

The processes described above can be stored in a memory of a computer system as a set of instructions to be executed. In addition, the instructions to perform the processes described above could alternatively be stored on other forms of machine-readable media, including magnetic and optical disks. For example the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system comprising:
at least one computer connected to a media content source and having a media content source storage device, wherein the at least one computer receives and classifies media content;
at least one of a visual output device and an audio output device;
a network connection; and
a global service directory maintained by a third party;
wherein the media content is user classifiable into at least one pre-selected classification; and
wherein playback of the media content is automatically determined based on a user's selection of at least one classification preference.

2. The system of claim 1, further comprising a local library of audio content.

3. The system of claim 1, further comprising a remote control for input to the computer.

4. The system of claim 1, wherein the global service directory further comprises at least one of an access authorization database, a global classification database, a global media cache, and a charge database.

5. The system of claim 1, wherein the classifications comprise at least the type of shot.

6. The system of claim 1, wherein the media content comprises audiovisual media.

7. A method comprising:
providing a tool for capturing media content, wherein the media content is stored in a media content storage;
providing a classifier to classify the captured media content;
allowing a user to classify media content with the classifier to form classified media content stored in a classification database; and
providing a player for playing the media content, wherein the player automatically selects media content after allowing a user to select preferences of classification categories.

8. The method of claim 7, further comprising connecting the classification database to a global directory service.

9. The method of claim 8, wherein the global directory service facilitates remote playback of classified media content by remote computers.

10. The method of claim 9, wherein the facilitation of remote playback is accomplished by determining if the remote computer is authorized to access the classified media content and if the remote computer is authorized to access the classified media content, giving the remote computer data to connect to the media content storage.

11. The method of claim 10, wherein classified media content is preauthorized to allow any entity to access the classified media content.

12. The method of claim 8, wherein the global directory service comprises a global media cache for storing frequently accessed classified media content;
wherein the frequently accessed classified media content is uploaded or streamed to a remote computer directly from the global directory service.

13. The method of claim 8, wherein the global directory service comprises a charge database wherein global directory service collects a fee for the viewing of classified media content.

14. The method of claim 7, wherein the player is configured to output media content to a television.

15. A machine readable medium having instructions stored thereon for performing a process comprising:
providing a tool for capturing media content, wherein the media content is stored in a media content storage;
providing a classifier to classify the captured media content;
allowing a user to classify media content with the classifier to form classified media content stored in a classification database; and
providing a player for playing the media content, wherein the player automatically selects media content after allowing a user to select preferences of classification categories.

16. The machine readable medium of claim 15, further comprising connecting the classification database to a global directory service.

17. The machine readable medium of claim 16, wherein the global directory service facilitates remote playback of classified media content by remote computers.

18. The machine readable medium of claim 17, wherein the facilitation of remote playback is accomplished by determining if the remote computer is authorized to access the classified media content and if the remote computer is authorized to access the classified media content, giving the remote computer data to connect to the media content storage.

19. The machine readable medium of claim 18, wherein classified media content is preauthorized to allow any entity to access the classified media content.

20. The machine readable medium of claim 16, wherein the global directory service comprises a global media cache for storing frequently accessed classified media content;
wherein the frequently accessed classified media content is uploaded or streamed to a remote computer directly from the global directory service.

21. The machine readable medium of claim 16, wherein the global directory service comprises a charge database wherein global directory service collects a fee for the viewing of classified media content.

22. The machine readable medium of claim 15, wherein the player is configured to output media content to a television.
